(19) United States
(12) Patent Application Publication
(10) Pub. No.: US 2012/0206026 A1
(43) Pub. Date: Aug. 16, 2012

(54) Concealed Security Cabinet

(76) Inventor: Fred Emelio, Slidell, LA (US)

(21) Appl. No.: 13/398,822

(22) Filed: Feb. 16, 2012

Related U.S. Application Data
(60) Provisional application No. 61/463,371, filed on Feb. 16, 2011.

(51) Int. Cl. A47B 81/00; E05B 47/00; E05B 65/44

(52) U.S. Cl. 312/204; 70/78

(57) ABSTRACT

The invention can include a cabinet having shelves in the front, a base with a rotation device, a mirror or backer on the back and a concealed locker between the backer and the shelves. The locker can be accessed through the manipulation of a magnetic locking mechanism or other mechanical mechanism that normally secures the backer in a closed position such that it looks like the backer is built into the back of the cabinet and no internal locker exists. To access the locker, a magnetic key is placed in proximity to the locking mechanism which causes the lock to release and allows the owner to swing open the mirror and access the interior of the locker. The existence of the locker is further veiled by the hidden hinges and locking mechanism so that a person unfamiliar with the device would not realize a locker was concealed therein.

### CROSS-REFERENCE TO RELATED APPLICATIONS

The application claims benefit of U.S. Provisional Application No. 61/463,371 entitled “Mirrored Cabinet and Concealed Security Locker” and filed on Feb. 16, 2011, which is specifically incorporated by reference herein for all that it teaches and discloses.

### TECHNICAL FIELD

The invention relates generally to the field of concealed storage, and more particularly to a security locker concealed within a cabinet.

### BACKGROUND

Unfortunately, home invasions and burglaries occur every day. In the United States, the second amendment guarantees the right to keep and bear arms. Thus, many choose to own a home defense weapon such as a shotgun, handgun, pepper-spray, etc. However, many burglaries occur when the occupants of a home are away. Thus, instead of being able to be used as a deterrent, many home defense weapons become just another item of personal property that is stolen by the burglar. Other items that are commonly taken are jewelry, cash, and gold and silver—any items that are relatively small and have a high value. Large items are difficult for a thief to hide and transport and thus are usually not the primary targets of a burglary.

Although many burglaries occur when the occupants are away, a large number also happen when the home is occupied. In such cases, if the occupants do have a home defense weapon, they need to be able to access it quickly before the burglars are able to restrain them or gain access to the weapon. Thus, the common reliance on a gun safe in the basement can defeat the utility of owning a home defense weapon if it is stored there, in a place that is difficult to access in a timely manner.

Therefore, it is important that a home defense weapon be stored in a readily accessible place in case the person is home when a burglary occurs; and yet, the weapon should not be placed so as to be easily found and stolen if a burglary occurs when the occupant is not home. It is also worthwhile to note that some people choose not to own a home defense weapon, although they often still have jewelry, cash, watches, silver, gold, etc. that a thief would quickly snap up during a burglary. As with the gun safe example above, storing such items in a secure safe locks them away, but also makes it difficult for the owner to access them quickly and easily on a daily basis and so many people won't take the time and effort to lock up these valuables between each use.

In addition to weapons and valuables, people often have items that they want to keep private, out of view, and/or away from children (such as adult DVDs, marital aids, etc.). However, it is once again quite inconvenient to store such items in a basement safe or hidden wall vault, not to mention that such items would then be taking up the usually limited space in such secure locations and displacing more valuable items that are more likely to be stolen in a burglary.

Thus, there is a need for a concealed security locker that is quickly and easily accessed by the owner and can hold a home defense weapon, high-value jewelry, silver, gold, private items, etc. A number of attempts have been made to address this need, but they fall short for various reasons. For example, a common device currently known in the art is a small metal lockbox that attaches under a bed frame or in a bed-side table. Such a lockbox is often configured to open by entering the correct combination or through fingerprint verification, etc. In any case, such a lockbox has a number of deficiencies. First, lockboxes are usually relatively small and although they can hold a handgun, they are usually not able to hold a shotgun or other larger-sized home defense weapon. Further, their limited size also makes it difficult to store cash, jewelry, etc. in such containers in addition to a weapon. Finally, if a thief arrives when the home is unoccupied, it is usually a relatively simple matter for a thief to locate and either remove the lockbox completely (to open later when time allows) or to open it on site with the application of a crowbar or other more specialized tools.

Another commonly employed device is a safe that is hidden within a wall compartment. The smaller varieties of such safes suffer from many of the same problems discussed above for the lockbox. If they are made large enough to overcome most of the lockbox limitations, then they need to be hidden away at the back of a closet or in some other inconvenient location which again makes them difficult for the owner to access in an emergency or on a daily basis, and so they are not used.

Thus, there remains a need for a concealed security locker that is easily accessible by the owner; is placed in a convenient, nearby location; can store home defense weapons, jewelry, watches, gold, silver, private items, etc.; is concealed and difficult for a thief to find and access; and otherwise bridges the gap between ensconcing items in a large, secured safe and leaving items on a shelf or otherwise out in the open.

### SUMMARY

One embodiment of the present invention is a free-standing, rotatable cabinet having a plurality of shelves in the front (like a curio cabinet), a solid base with a rotation device, a full-length mirror on the back and a concealed locker behind the mirror. In another embodiment, the mirror is replaced with a backer. The locker can be accessed through the manipulation of a magnetic or mechanical locking mechanism that normally secures the mirror or backer in a closed position such that it looks like the mirror or backer is built into the back of the cabinet and no internal locker exists. When the owner wishes to access the locker, a magnetic key is placed in proximity to the locking mechanism which causes the lock to release and allows the owner to swing open the mirror and access the interior of the locker. In another embodiment, a mechanical release mechanism is used in place of the magnetic mechanism. The locker can be dimensioned to have approximately the same height and width as the cabinet, but its depth is preferably kept relatively small in order to ensure that its existence is kept properly obfuscated.

The full-length mirror serves two purposes: first, it is useful to have a full-length dressing mirror available for examining one's appearance, ensuring that clothing is appropriate and positioned correctly, trying on jewelry and other items, etc.; second, the optical properties of mirrors serve to conceal and obfuscate the existence of the locker behind the mirror. It is difficult for the human eye to ignore the reflections in mirrors so as to allow a person to properly gauge the depth of the cabinet versus the location of the mirror on the back side. The space in which the locker exists is thus difficult for a person to discern; instead, the mirror looks to be placed directly on the back wall of the cabinet with no intervening space for a concealed locker.

The existence of the locker is further veiled by the hidden hinges and locking mechanism so that a person unfamiliar with the device would not realize a locker was concealed therein. Additionally, the normal gap found between a door and its frame is hidden by application of surround molding or similar components that are attached to the door and surround the side of the cabinet when the door is closed. Such components closely mate with similar components on the side of the cabinet and further obfuscate the existence of a door and locker. In another embodiment, the mirror or back is recessed within the back of the cabinet within a frame or other obfuscating components such that only the mirror or backer can be removed, leaving the rest of the back of the cabinet in place and not requiring the use of a door and surround molding.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates an elevated view of the front side of an exemplary embodiment of a concealed security cabinet in accordance with an aspect of the present invention;

FIG. 2 illustrates an elevated view of the back side of an exemplary embodiment of a concealed security cabinet;

FIG. 3 illustrates a perspective view of the right side and back side of an exemplary embodiment of a concealed security cabinet showing that the hinges are completely hidden;

FIG. 4 illustrates a perspective view of the left side and back side of an exemplary embodiment of a concealed security cabinet showing that the latch and the gap between the door and the left side are completely hidden;

FIG. 5 illustrates a perspective view of an exemplary embodiment of a hidden hinge that is attached to a hinge sidewall of the interior of the concealed security cabinet and to the back of the backer;

FIG. 6A illustrates a perspective view of an exemplary embodiment of the back of the backer mirror as well as the side molding component and the magnetic locking mechanism;

FIG. 6B illustrates a perspective view of an exemplary embodiment of the front of the door showing the magnetic key in position to actuate the magnetic locking mechanism shown in FIG. 6A;

FIG. 7A illustrates a perspective view of an exemplary embodiment of the bottom portion of the back side of a concealed security cabinet including the base before rotation;

FIG. 7B illustrates a perspective view of an exemplary embodiment of the bottom portion of the back side of a concealed security cabinet including the base after a forty-five degree rotation;

FIG. 8 illustrates a perspective view of the interior of an exemplary embodiment of the concealed security cabinet depicting a locker having a shelf and jewelry pegs;

FIG. 9 illustrates a perspective view of the top portion of the cabinet showing an exemplary embodiment of the top;

FIG. 10 illustrates a perspective view of the bottom portion of an exemplary embodiment of the interior of a locker depicting placement and storage of weapons;

FIG. 11 illustrates a perspective view of the interior of an exemplary embodiment of the concealed security cabinet depicting the latch sidewall and the magnetic latch;

FIG. 12 illustrates a perspective view of an exemplary backer board that does not have a mirror and uses attachments to hold the backer board in place in the backer;

FIG. 13 illustrates an exemplary backer actuator that can be used to push open a backer; and

FIG. 14 illustrates a concealed security cabinet that does not utilize a rotatable attachment between the base and the plurality of shelves.

### DETAILED DESCRIPTION

Referring now to the drawings, exemplary embodiments of the invention are described below in the accompanying Figures. The following detailed description provides a comprehensive review of the drawings in order to provide a thorough understanding of, and an enabling description for, these embodiments. One having ordinary skill in the art will understand that the invention may be practiced without certain details. In other instances, well-known structures and functions have not been shown or described in detail to avoid unnecessarily obscuring the description of the embodiments.

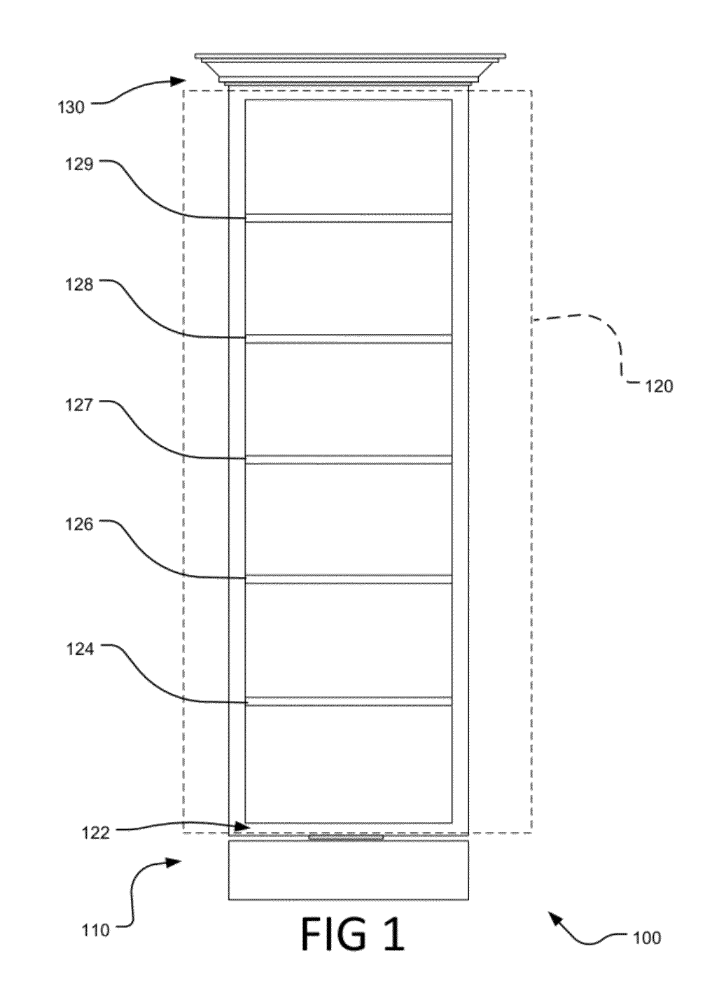

FIG. 1 illustrates an elevated view of the front side of an exemplary embodiment of a concealed security cabinet 100 in accordance with an aspect of the present invention. The concealed security locker 100 has a base 110, a shelf section 120, and a top 130.

The base 110 can have a bottom portion that rests upon the floor and a top portion that is attached to a rotation device which is further attached to the shelf section 120 such that the shelf section 120 is rotatably attached to the top portion of the base 110. The base 110 can be generally shaped like a brick or box having four sides, a top and a bottom. The base can have a horizontal cross section that appears generally to be a quadrilateral or rectangle and preferably, an approximate square.

In the embodiment shown in FIG. 1, the shelf section 120 has six shelves 122, 124, 126, 127, 128 and 129. In other embodiments, the number of shelves 122, 124, 126, 127, 128, and 129 can be less than or more than five. Similarly, the shelves 122, 124, 126, 127, 128, and 129 can be configured differently—e.g., there could be a vertical storage area on one side of the shelves 122, 124, 126, 127, 128, and 129, or the shelves could be made so that they can be relocated by the user, etc.—without departing from the scope of the invention.

The shelf section 120 is depicted as being surrounded by a broken-line (or dashed) box. This box is for illustration only and forms no part of the claimed invention. The height, width, and depth of the cabinet illustrated in FIG. 1 is for this particular exemplary embodiment, other dimensions are contemplated and are within the scope of the invention.

The shelves 122, 124, 126, 127, 128, and 129 can be used for various purposes. For example, if the cabinet 100 is located in a bedroom, the shelves 122, 124, 126, 128, and 129 can be used for hats, shoes, belts, coins, colognes/perfumes, etc. If the cabinet 100 is located in a garage, the shelves 122, 124, 126, 128, and 129 can be used for oil, filters, rags, cleaning supplies, tools, etc. Furthermore, instead of having bare exterior sides, the sides can have pegs for holding hand tools, sockets, wrenches, hammers, etc.

Although the cabinet 100 is shown in the FIGS. as being constructed mainly of wood, other building materials may be used, including, but not limited to: metal, plastic, fiberglass, etc. A combination of various materials may also be employed.

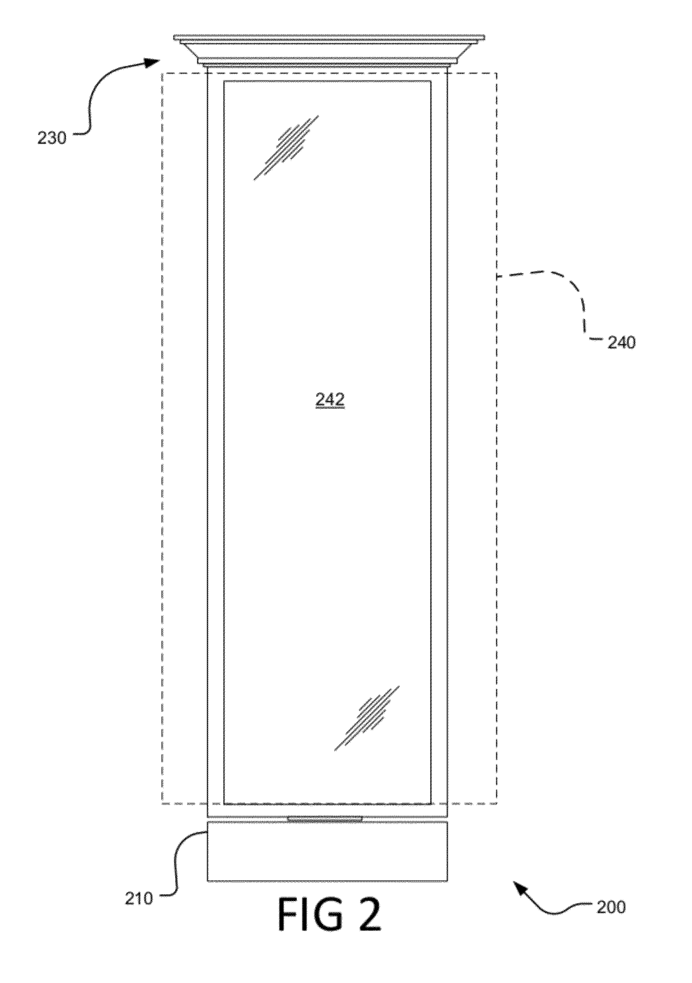

FIG. 2 illustrates an elevated view of the back side of an exemplary embodiment of a concealed security cabinet 200. As in FIG. 1, the base 210 and top 230 are shown. But as this is the back of the cabinet 240, the shelves are not visible. Instead, the back of the cabinet 240 comprises a mirror 242 in a frame. In another embodiment, a backer board is used in place of the mirror. The backer board or mirror 242 serves at least two purposes: first, it is useful to have a full-length dressing mirror 242 available for examining one's appearance, ensuring that clothing is appropriate and positioned correctly, trying on jewelry and other items, etc.; second, the optical properties of the mirror 242 serves to conceal and obfuscate the existence of the locker behind the mirror 242. It is difficult for the human eye to ignore the reflections in mirrors so as to allow a person to properly gauge the depth of the cabinet 200 versus the location of the mirror 242 on the back side 240. The space in which the locker exists is thus difficult for a person to discern; instead, the mirror 242 looks to be placed directly on the back wall of the cabinet 200 with no intervening space for a concealed locker. The mirror's 242 frame is not labeled in FIG. 2, see later figures. The frame serves to further obfuscate the existence of the locker by hiding the joints, edges, and corners of the cabinet 200.

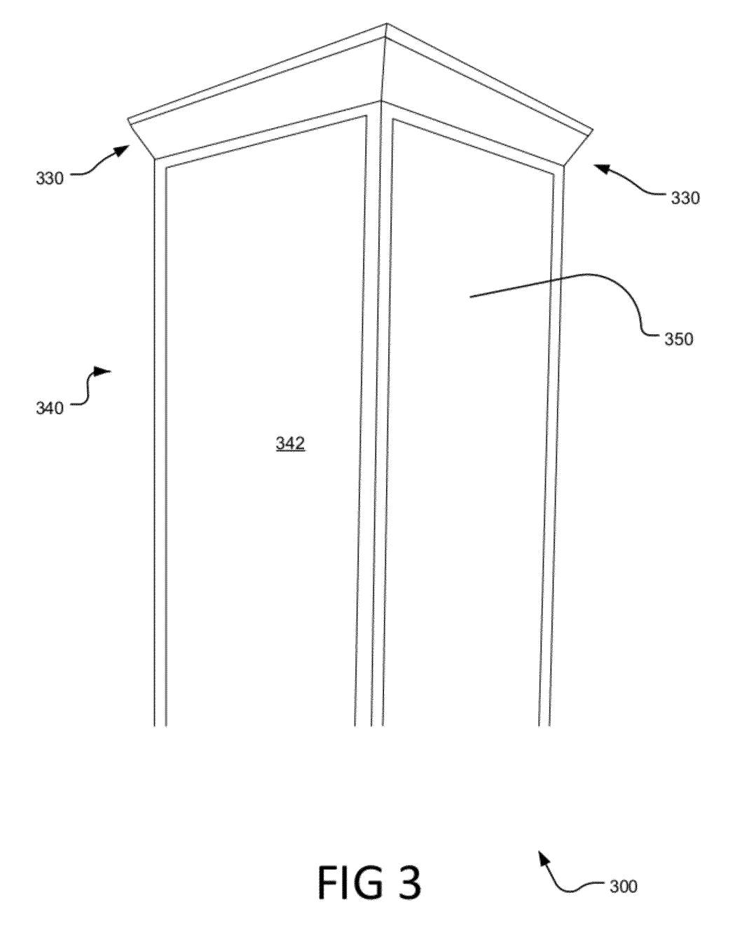

FIG. 3 illustrates a perspective view of the right side 350 and back side 340 of an exemplary embodiment of a concealed security cabinet 100 showing that the hinges are completely hidden. The hinges are internal and are located where the right side 350 joins the back side 340. As can be seen in FIG. 3, no hinges are visible. Also shown in FIG. 3 are two side portions of the top 330 and the mirror 342. Although the right side 350 shown in FIG. 3 is rather plain, it is contemplated that in another embodiment, the right side 350 could also have a mirror, corkboard, decoration, belt/tie pegs, etc.

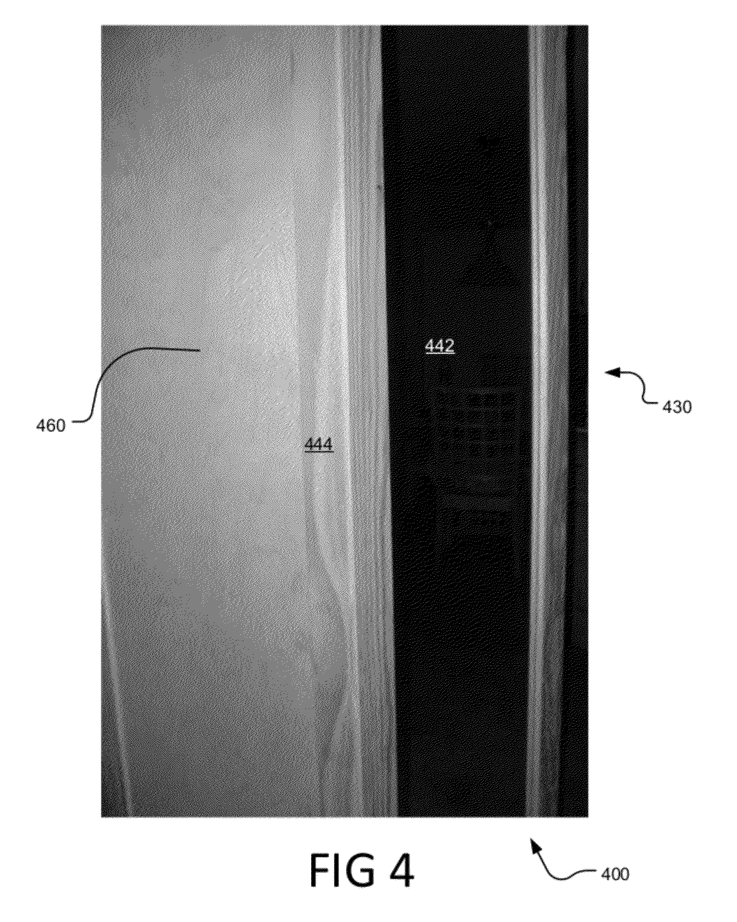

FIG. 4 illustrates a perspective view of the left side 460 and back side 430 of an exemplary embodiment of a concealed security cabinet 400 showing that the latch and the gap between the door and the left side 460 are completely hidden. The mirror 442 is shown with a frame (not labeled, see later figures) and a molding component 444. This component 444 covers what would otherwise be a gap between the door and the left side 460.

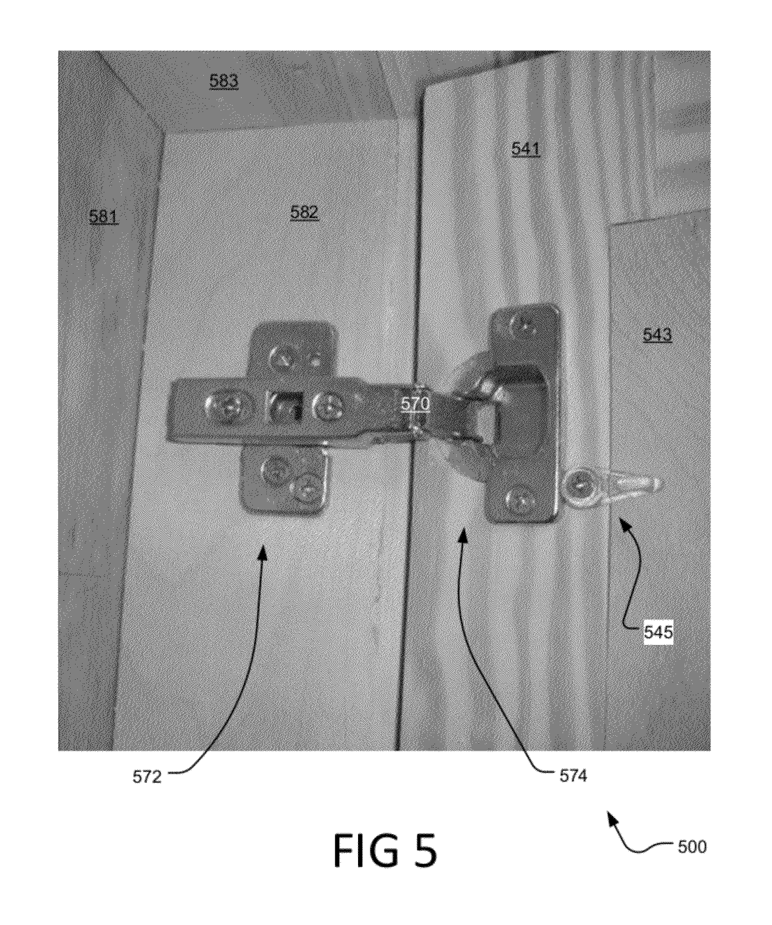

FIG. 5 illustrates a perspective view of an exemplary embodiment of a hidden hinge 570 that is attached to a hinge sidewall 582 of the interior of the concealed security cabinet 500 and to the back of the backer. The interior of the concealed security locker 500 is partially illustrated in FIG. 5 as having a hinge sidewall 582, a top wall 583, and a back wall 581. As can be seen in FIG. 5, all three walls 581, 582, and 583 abut one another at approximately right angles. The hinge 570 has two components: a mounting plate 572 and a cup and arm 574. The hinge 570 shown in FIG. 5 is one of a plurality of hinges, the number can be one, two, three, four, or more, but the preferred number of hinges is three. The plurality of hinges 570 can be configured to displacably attach the backer to the shelf section. Hinges allow the backer to be partially affixed to the shelf section but yet be swung open or displaced from a closed location into an open location.

The back of the door and mirror are depicted in FIG. 5 with the following components: the backing 543, the interior door frame 541, and the mirror locking clips 545. The backing 543 is attached to the backside of the mirror and serves to strengthen the mirror and allow it to be secured to the door. The frame 541 surrounds the mirror and backing 543 and serves to provide shape and strength to the door. Although only one of the mirror locking clips 545 is shown in FIG. 5, a plurality of such clips are used to ensure that the mirror is locked in place within the door.

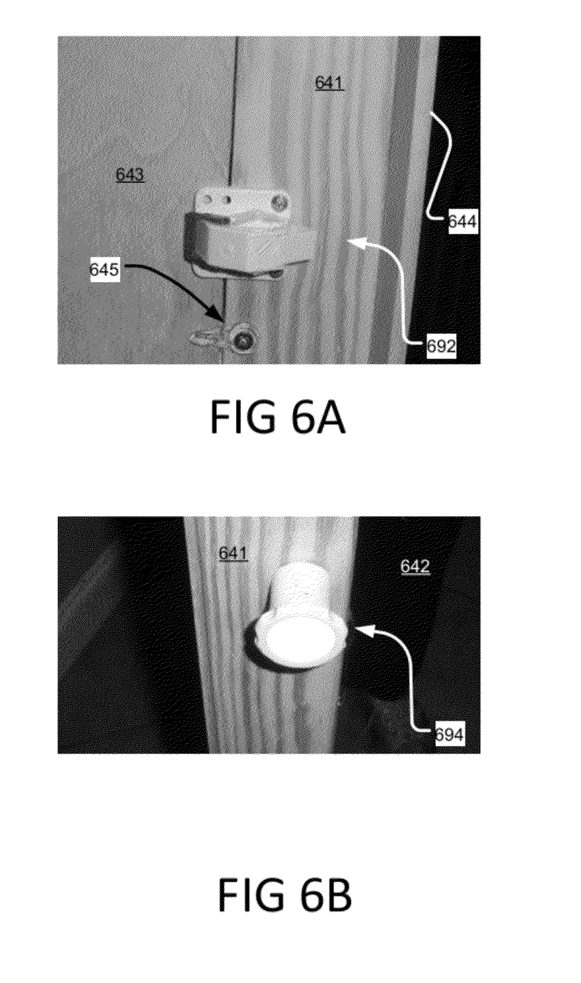

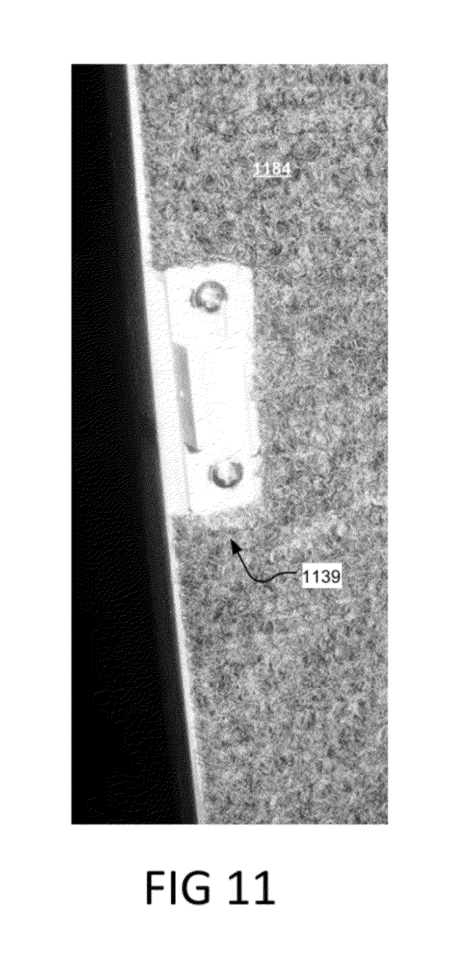

FIG. 6A illustrates a perspective view of an exemplary embodiment of the back of the backer mirror as well as the side molding component and the magnetic locking mechanism 692. The back of the door and mirror are depicted in FIG. 6 with the following components: the backing 643, the interior door frame 641, the mirror locking clips 645, and the molding component 644. The backing 643 is attached to the backside of the mirror and serves to strengthen the mirror and allow it to be secured to the door. The frame 641 surrounds the mirror and backing 543 and serves to provide shape and strength to the door. The magnetic locking mechanism 692 is positioned so that is can interact with the magnetic latch on the inside of the security locker (see FIG. 11) to lock and unlock the door.

FIG. 6B illustrates a perspective view of an exemplary embodiment of the front of the door showing the magnetic key 694 (or actuator) in position to actuate the magnetic locking mechanism shown 692 in FIG. 6A. In another embodiment, the locking mechanism is mechanical and not magnetic. In the illustration in FIG. 6A, the magnetic key 694 can be completely removed from the cabinet with a simple firm tug. It can then be placed in a hidden location or just left in a nearby drawer as its function is difficult to ascertain when it is not attached to the cabinet. The key 694 contains one or more powerful magnets that exert a magnetic force through the frame 641 and actuate the magnetic locking mechanism 692. By manipulating the key 694, a person can lock or unlock the door to the cabinet. FIG. 6B also shows the front side of the mirror 642.

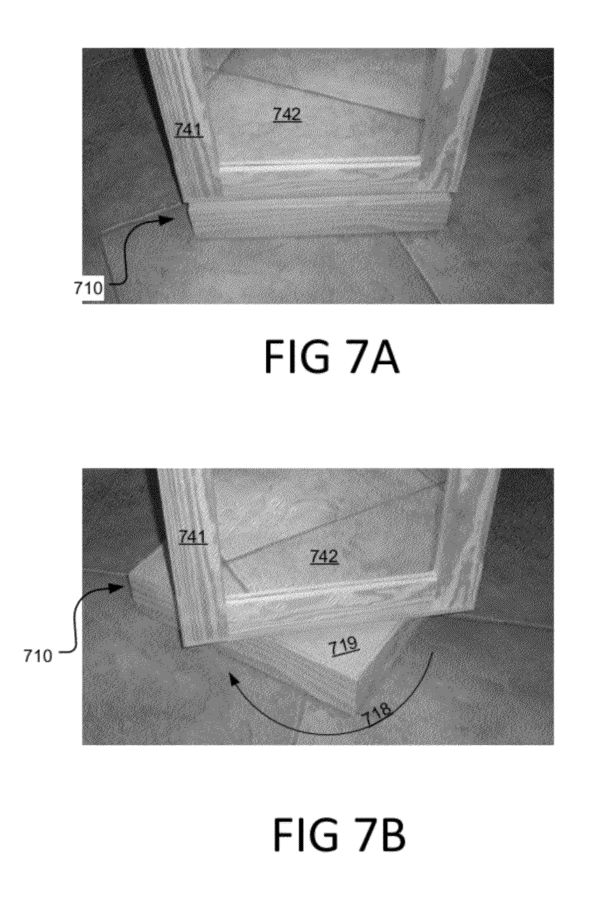

FIG. 7A illustrates a perspective view of an exemplary embodiment of the bottom portion of the back side of a concealed security cabinet including the base 710 before rotation. Also shown in FIG. 7A is the mirror 742 and the frame 741. Notice how the bottom of the frame 741 is in close proximity and runs parallel with the top edge of the sidewall of the base 710 in this figure.

FIG. 7B illustrates a perspective view of an exemplary embodiment of the bottom portion of the back side of a concealed security cabinet including the base 710 after a forty-five degree rotation 718. Notice how the bottom of the frame 741 has been rotated relative to the base and so no longer runs parallel with the top edge of a sidewall of the base 710. The base 710 appears to be a solid, three-dimensional box in FIGS. 7A-B. However, in one embodiment, the base 710 is filled with lead or another heavy substance to provide stability to the cabinet. In another embodiment, the base 710 contains an additional secret compartment that is accessed by unlocking the shelf section so that it can rotate relative to the base and then the area depicted as 719 is an open hatch that allows access to the interior of the cabinet. The rotation locking mechanism, although not shown in FIG. 7B, could be similar to that shown in FIGS. 6A-B and would be positioned near the bottom corner of the frame so that it could latch onto the top surface of the base 710.

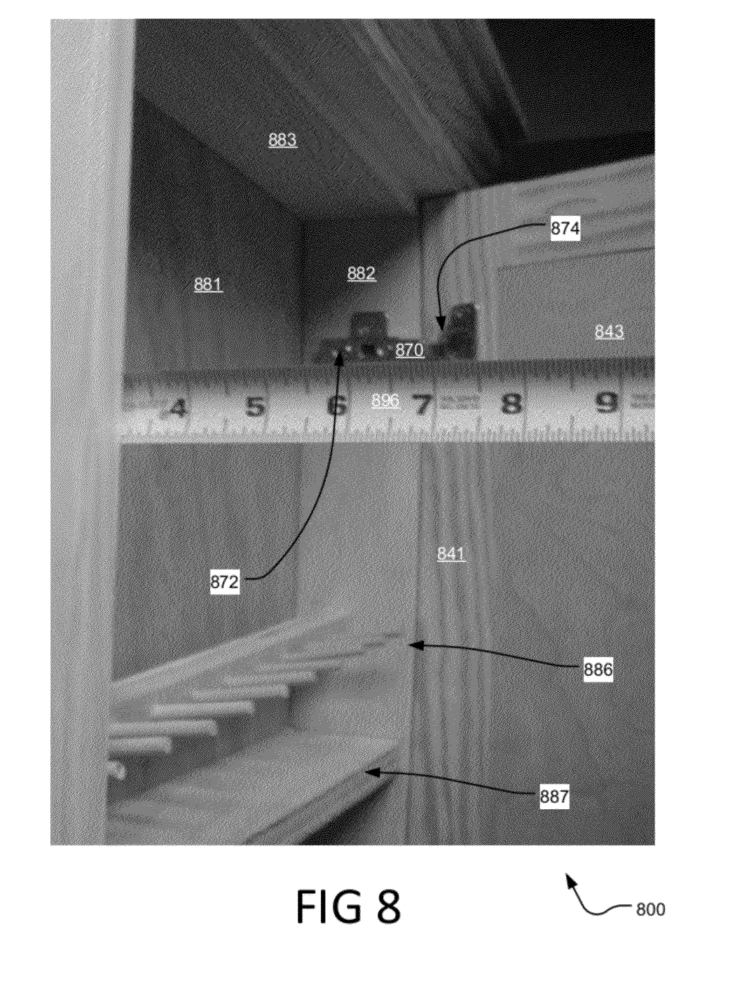

FIG. 8 illustrates a perspective view of the interior of an exemplary embodiment of the concealed security cabinet 800 depicting a locker having a shelf 887 and jewelry pegs 886. The interior of the concealed security locker 800 is partially illustrated in FIG. 8 as having a hinge sidewall 882, a top wall 883, and a back wall 881. As can be seen in FIG. 8, all three walls 881, 882, and 883 abut one another at approximately right angles. The hinge 870 has two components: a mounting plate 872 and a cup and arm 874 (see FIG. 5 for more detail). The hinge 870 shown in FIG. 8 is one of a plurality of hinges, the number can be one, two, three, four, or more, but the preferred number of hinges is three.

The back of the door and mirror are depicted in FIG. 8 with the following components: the backing 843 and the interior door frame 841. The backing 843 is attached to the backside of the mirror and serves to strengthen the mirror and allow it to be secured to the door. The frame 841 surrounds the mirror and backing 843 and serves to provide shape and strength to the door.

Inside the top portion of the security locker, a set of internal components is shown, including, but not limited to: a row of jewelry pegs 886 and a shelf 887. In another embodiment, the internal components could be configured differently and could include different components such as necklace pegs, bracelet holders, cufflink shelves, DVD holders, etc. Furthermore, the shelf 887 shown in FIG. 8 could have a lip added thereto to ensure that objects placed on the shelf 887 were not able to roll off it when the door was opened. A measuring tape 896 is included in FIG. 8 in order to show the approximate depth of this embodiment of the security cabinet (approximately 3 inches) and forms no part of the claimed invention. In other embodiments, other depths are contemplated.

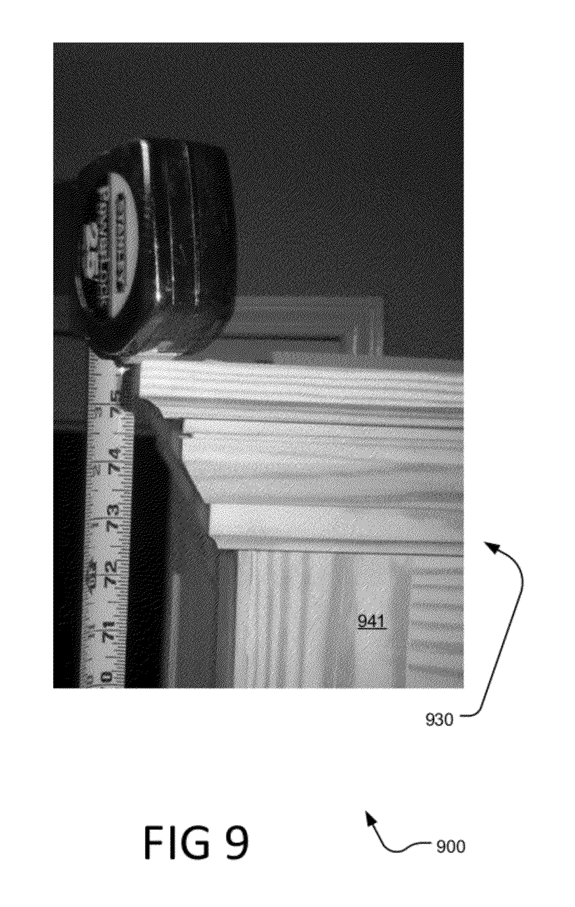

FIG. 9 illustrates a perspective view of the top portion of the cabinet showing an exemplary embodiment of the top 930. The top portion of the frame 941 is visible as is a tape measure showing the approximate height of this particular embodiment of the cabinet as being about seventy five and one half inches. The tape itself forms no part of the invention and is displayed only to show an approximate height of one particular embodiment; other embodiments are contemplated having heights much different from that shown in FIG. 9. The top 930 is shown as having a decorative shape in FIG. 9. This shape, although mostly decorative, also serves to obfuscate the existence of the door to the concealed security locker. Other shapes can be used, but they should approximate similar horizontal furniture moldings and features in order to draw the eye away from the joint where the top of the door frame 941 meets the bottom portion of the top 930.

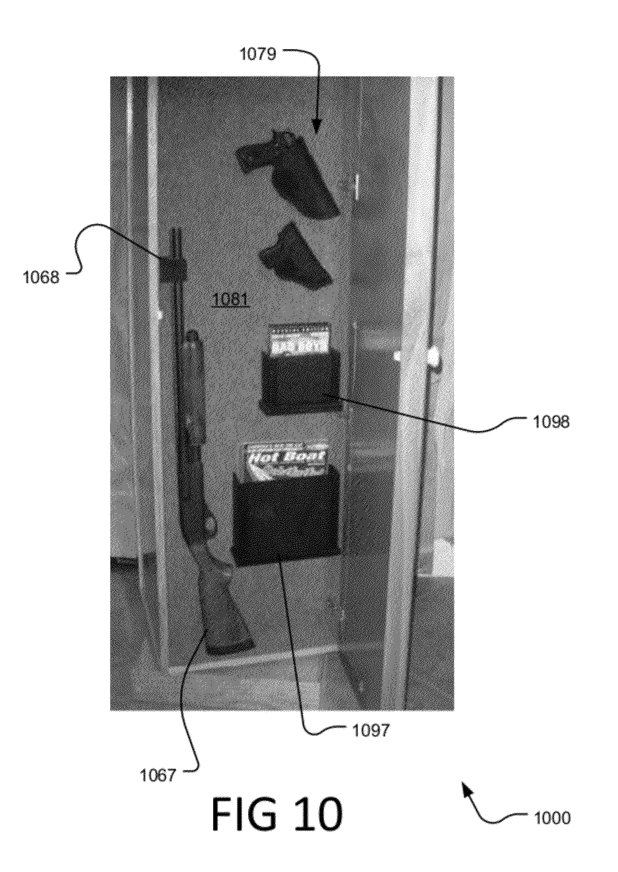

FIG. 10 illustrates a perspective view of the bottom portion of an exemplary embodiment of the interior of a locker 1000 depicting placement and storage of weapons. The interior of the concealed security locker 1000 is partially illustrated in FIG. 10 as having a back wall 1081 that is shown covered in gray carpet. Other coverings are contemplated. The bottom portion of the security locker can be configured to secure a plurality of secreted items, which may include, but not be limited to, any of those pictured in FIG. 10: a home-defense shotgun 1067, a plurality of handguns 1079, an audio/visual rack 1098, and a magazine rack 1097. The shotgun 1067 is held in place by a barrel holder 1068 and the handguns are secured via holsters. In other embodiments, the location and number of barrel holders 1068, holsters, and racks can vary from that shown in FIG. 10. Furthermore, other implements for securing other articles are contemplated.

FIG. 11 illustrates a perspective view of the interior of an exemplary embodiment of the concealed security cabinet depicting the latch sidewall 1184 and the magnetic latch 1139. The latch 1139 is mounted on the latch sidewall 1184 and engages the magnetic locking mechanism (see item 692, FIG. 6) to keep the door to the security locker closed. When the magnetic key (see item 694, FIG. 6) is used to actuate the locking mechanism, the mechanism releases the latch 1139 and the door is unlocked, allowing the user to swing it open. Other shapes of latches are contemplated as are other mounting means.

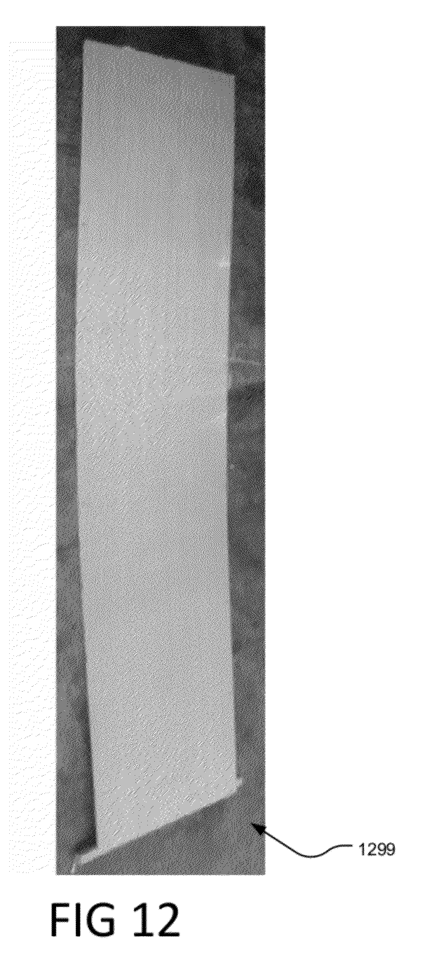

FIG. 12 illustrates a perspective view of an exemplary backer board 1299 that does not have a mirror and uses attachments to displacably hold the backer board in place in the backer. In this embodiment, the backer comprises a backer board and a plurality of holding areas placed around the inside of the backer board such that the holding areas can be placed against attachment points on the backer. The backer attachment points work in concert with the backer board holding areas to displacably or removably attach the backer board to the backer. In one embodiment, the holding areas and the attachment points both comprise magnetically responsive materials such as ferrous metal and/or magnets such that when the backer board is placed in proximity to the backer frame, the holding areas align with the attachment points and the areas and points attract one another with sufficient force to hold the backer board in place on the backer. In another embodiment, the attachment points and the holding areas utilize hook and look materials that displacably and/or removably hold the backer board in place on the backer.

The backer frame can comprise a molding component (as discussed above) or it can be a frame that outlines the mirror or backer board and creates a recessed area for the mirror or backer board to rest in so that any gap between the mirror or backer board and the backer is obfuscated by the backer frame. Any such gap might otherwise give away the presence of the concealed security locker that is hidden behind the mirror or backer board and between that component and the shelf section.

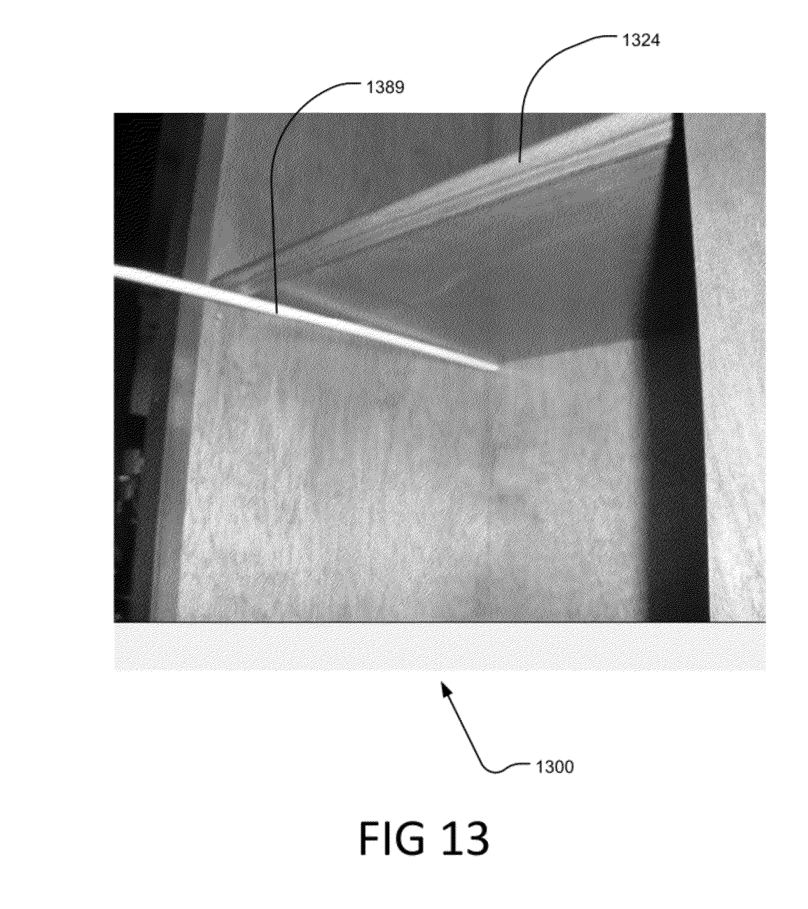

FIG. 13 illustrates an exemplary backer actuator 1389 that can be used to push open at least a component of the backer. The view illustrated in FIG. 13 shows only a portion of the components of a concealed security cabinet 1300. The actuator 1389 is an opening mechanism that can be used in place of the magnetic key and magnetic switch (alternative embodiment opening mechanisms) to push the backer board or mirror away from the backer. The actuator 1389 provides sufficient actuating force to break the plurality of attachments between the backer and the backer board or mirror; as discussed above, the attachment can be magnetic, such as magnets or magnets and magnetically active metal, or mechanical, such as hook and loop, etc. Once the initial contact between the two components is broken, the user can physically swing out or otherwise remove the backer board or mirror.

The actuator 1389 can be hidden under the shelf 1324 as illustrated in FIG. 13. In other embodiments, other locations and/or means can be utilized to conceal or hide the actuator 1389 from casual observation.

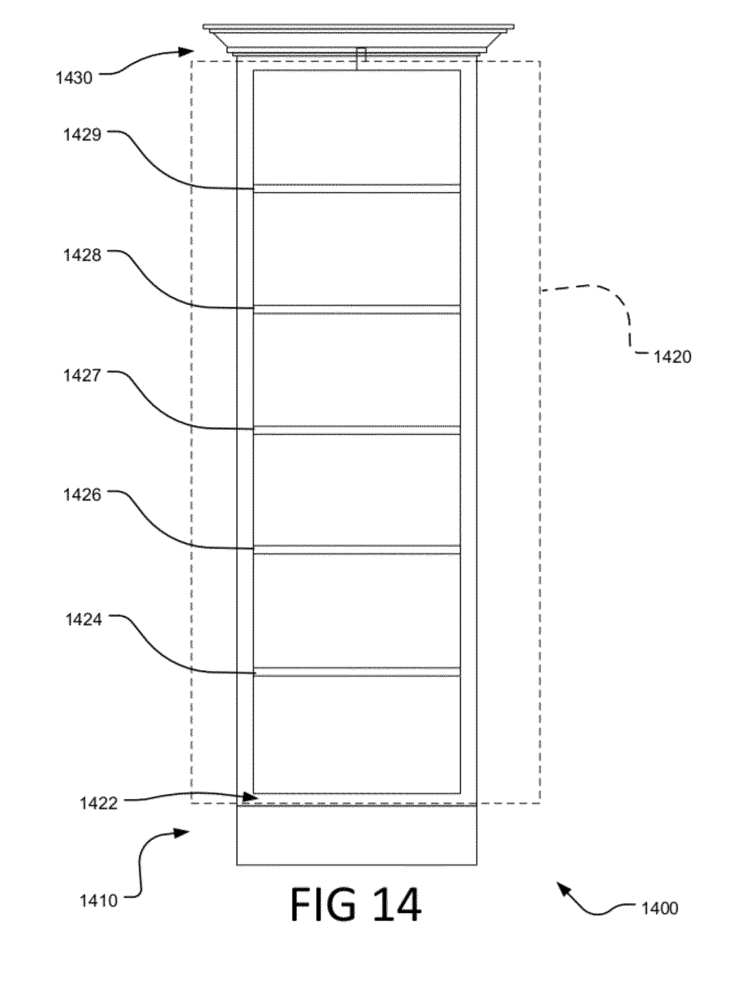

FIG. 14 illustrates a concealed security cabinet 1400 that does not utilize a rotatable attachment between the base 1410 and the plurality of shelves 1420. Also shown are the top 1430 and the shelves 1422, 1424, 1426, 1427, 1428 and 1429. In this configuration, the plurality of shelves 1420 does not rotate relative to the base 1410. Thus, the user would have to pull the cabinet 1400 away from the wall manually before accessing the backer and the security locker. Although not shown in FIG. 14, the cabinet 1400 may be mounted on wheels to make it easier for the user to access the locker.

While particular embodiments of the invention have been described and disclosed in the present application, it should be understood that any number of permutations, modifications, or embodiments may be made without departing from the spirit and scope of this invention. Accordingly, it is not the intention of this application to limit this invention in any way except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise embodiment or form disclosed herein or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

In light of the above “Detailed Description,” the Inventor may make changes to the invention. While the detailed description outlines possible embodiments of the invention and discloses the best mode contemplated, no matter how detailed the above appears in text, the invention may be practiced in a myriad of ways. Thus, implementation details may vary considerably while still being encompassed by the spirit of the invention as disclosed by the inventor. As discussed herein, specific terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

The above specification, examples and data provide a description of the structure and use of exemplary implementations of the described articles of manufacture and methods. It is important to note that many implementations can be made without departing from the spirit and scope of the invention.

What is claimed is:

1. A concealed security cabinet, comprising:
a base having a top portion and a bottom portion, the bottom portion configured to rest upon a floor and support the concealed security cabinet;
a shelf section having a plurality of shelves in front and a backer in back and rotatably attached to the top portion of the base;
the backer positioned at the back of the shelf section and configured so that at least a portion of the backer can be opened to reveal a concealed security locker between the plurality of shelves and the backer;
a plurality of attachments configured between the backer and the plurality of shelves that enable at least a portion of the backer to be displaceably attached to the shelf section when in a closed position;
a molding component attached to the backer that is designed to obfuscate an existence of the concealed security locker, wherein the concealed security locker is configured to hide a plurality of secreted items; and
an opening mechanism configured to allow at least a portion of the backer to be released from attachment to the shelf section.

2. The concealed security cabinet of claim 1 wherein the plurality of attachments include at least a plurality of hidden hinges.

3. The concealed security cabinet of claim 1 wherein the plurality of attachments include a plurality of holding areas placed around an inside of the backer board and a plurality of attachment points placed around the backer, wherein the plurality of holding areas can be placed against the plurality of attachment points in order to displacably hold the backer board against the backer.

4. The concealed security cabinet of claim 3 wherein the plurality of holding areas and the plurality of attachment points both comprise magnetically responsive materials such that when the backer board is placed in proximity to the backer frame, the plurality of holding areas align with the plurality of attachment points and the areas and points attract one another with sufficient force to hold the backer board in place on the backer.

5. The concealed security cabinet of claim 3 wherein the plurality of attachment points and the plurality of holding areas utilize hook and look materials that displacably hold the backer board in place on the backer.

6. The concealed security cabinet of claim 1 wherein the opening mechanism comprises:
a magnetic locking mechanism attached to the backer and configured to keep the backer configured in a closed position until activated; and
a magnetic key that activates the magnetic locking mechanism and thereby reconfigures the magnetic locking mechanism in an open position and opens the backer revealing the concealed security locker.

7. The concealed security cabinet of claim 1 wherein the opening mechanism comprises a backer actuator and wherein the backer actuator is a push rod that extends from the backer into the shelf section and is configured so that when activated the backer actuator pushes open the backer.

8. The concealed security cabinet of claim 2 wherein the opening mechanism comprises:
a magnetic locking mechanism attached to the backer and configured to keep the backer configured in a closed position until activated; and
a magnetic key that activates the magnetic locking mechanism and thereby reconfigures the magnetic locking mechanism in an open position and opens the backer revealing the concealed security locker.

9. The concealed security cabinet of claim 2 wherein the opening mechanism comprises a backer actuator and wherein the backer actuator is a push rod that extends from the backer into the shelf section and is configured so that when activated the backer actuator pushes open the backer.

10. The concealed security cabinet of claim 3 wherein the opening mechanism comprises:
a magnetic locking mechanism attached to the backer and configured to keep the backer configured in a closed position until activated; and
a magnetic key that activates the magnetic locking mechanism and thereby reconfigures the magnetic locking mechanism in an open position and opens the backer revealing the concealed security locker.

11. The concealed security cabinet of claim 3 wherein the opening mechanism comprises a backer actuator and wherein the backer actuator is a push rod that extends from the backer into the shelf section and is configured so that when activated the backer actuator pushes open the backer.

12. The concealed security cabinet of claim 4 wherein the opening mechanism comprises:
a magnetic locking mechanism attached to the backer and configured to keep the backer configured in a closed position until activated; and
a magnetic key that activates the magnetic locking mechanism and thereby reconfigures the magnetic locking mechanism in an open position and opens the backer revealing the concealed security locker.

13. The concealed security cabinet of claim 4 wherein the opening mechanism comprises a backer actuator and wherein the backer actuator is a push rod that extends from the backer into the shelf section and is configured so that when activated the backer actuator pushes open the backer.

14. The concealed security cabinet of claim 5 wherein the opening mechanism comprises:
a magnetic locking mechanism attached to the backer and configured to keep the backer configured in a closed position until activated; and
a magnetic key that activates the magnetic locking mechanism and thereby reconfigures the magnetic locking mechanism in an open position and opens the backer revealing the concealed security locker.

15. The concealed security cabinet of claim 5 wherein the opening mechanism comprises a backer actuator and wherein the backer actuator is a push rod that extends from the backer into the shelf section and is configured so that when activated the backer actuator pushes open the backer.
